(19) United States
(12) Patent Application Publication
(10) Pub. No.: US 2004/0058193 A1
(43) Pub. Date: Mar. 25, 2004

(54) White organic light-emitting devices with improved performance

(75) Inventor: Tukaram K. Hatwar, Penfield, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/244,314

(22) Filed: Sep. 16, 2002

(51) Int. Cl. H05B 33/14

(52) U.S. Cl. 428/690; 428/917; 428/332; 313/504; 313/506; 313/112; 257/98

(57) ABSTRACT

An organic light-emitting diode (OLED) device which produces substantially white light including a substrate, an anode disposed over the substrate, and a hole injecting layer disposed over the anode. The device also includes a hole-transporting layer disposed over the hole injecting layer, a blue light-emitting layer doped with a blue light-emitting compound disposed directly on the hole-transporting layer, and an electron-transporting layer disposed over the blue light-emitting layer. The device further includes a cathode disposed over the electron-transporting layer and the hole-transporting layer or electron-transporting layer, or both the hole-transporting layer and electron-transporting layer, being selectively doped with super rubrene or derivatives thereof which emits light in the yellow region of the spectrum which corresponds to an entire layer or a partial portion of a layer in contact with the blue light-emitting layer.

### CROSS REFERENCE TO RELATED APPLICATIONS

Reference is made to commonly assigned U.S. patent application Ser. No. 09/651,624 filed Aug. 30, 2000 by Tukaram K. Hatwar, entitled “White Organic Electroluminescent Devices with Improved Stability and Efficiency”; Ser. No. 09/930,050 filed Aug. 15, 2001 by Tukaram K. Hatwar, entitled “White Organic Electroluminescent Devices with Improved Efficiency”; Ser. No. 10/191,251 filed July, 2002 by Tukaram K. Hatwar, entitled “White Organic Light-Emitting Devices Using Rubrene Layer”; Ser. No. 10/183,242 filed Jun. 27, 2002 by Benjamin P. Hoag et al., entitled “Organic Element for Electroluminescent Devices”; Ser. No. 10/086,067 filed Feb. 28, 2002 by Benjamin P. Hoag et al., entitled “Organic Element for Electroluminescent Devices”; and Ser. No. 10/184,356 filed Jun. 27, 2002 by Lelia Cosimbescu, entitled “Device Containing Green Organic Light-Emitting Diode”, the disclosures of which are incorporated herein.

### FIELD OF THE INVENTION

The present invention relates to organic light-emitting OLED devices, which produce white light.

### BACKGROUND OF THE INVENTION

An OLED device includes a substrate, an anode, a hole-transporting layer made of an organic compound, an organic luminescent layer with suitable dopants, an organic electron-transporting layer, and a cathode. OLED devices are attractive because of their low driving voltage, high luminance, wide-angle viewing and capability for full-color flat emission displays. Tang et al. described this multilayer OLED device in their U.S. Pat. Nos. 4,769,292 and 4,885,211.

Efficient white light producing OLED devices are considered as low cost alternative for several applications such as paper-thin light sources, backlights in LCD displays, automotive dome lights, and office lighting. White light producing OLED devices should be bright, efficient, and generally have Commission International d'Eclairage (CIE) chromaticity coordinates of about (0.33, 0.33). In any event, in accordance with this disclosure, white light is that light which is perceived by a user as having a white color.

The following patents and publications disclose the preparation of organic OLED devices capable of emitting white light, comprising a hole-transporting layer and an organic luminescent layer, and interposed between a pair of electrodes.

White light producing OLED devices have been reported before by J. Shi (U.S. Pat. No. 5,683,823) wherein the luminescent layer includes red and blue light-emitting materials uniformly dispersed in a host emitting material. This device has good electroluminescent characteristics, but the concentration of the red and blue dopants are very small, such as 0.12% and 0.25% of the host material. These concentrations are difficult to control during large-scale manufacturing. Sato et al. in JP 07,142,169 discloses an OLED device, capable of emitting white light, made by sticking a blue light-emitting layer next to the hole-transporting layer and followed by a green light-emitting layer having a region containing a red fluorescent layer.

Kido et al., in Science, Vol. 267, p. 1332 (1995) and in APL Vol. 64, p. 815 (1994), report a white light producing OLED device. In this device three emitter layers with different carrier transport properties, each emitting blue, green or red light, are used to generate white light. Littman et al. in U.S. Pat. No. 5,405,709 disclose another white emitting device, which is capable of emitting white light in response to hole-electron recombination, and comprises a fluorescent in a visible light range from bluish green to red. Recently, Deshpande et al., in Applied Physics Letters, Vol. 75, p. 888 (1999), published white OLED device using red, blue, and green luminescent layers separated by a hole blocking layer.

However, these OLED devices require a very small amount of dopant concentrations, making the process difficult to control for large-scale manufacturing. Also, emission color varies due to small changes in the dopant concentration. White OLEDS are used making full-color devices using the color filters. However, the color filter transmits only about 30% of the original light. Therefore, high luminance efficiency and stability are required for the white OLEDs.

### SUMMARY OF THE INVENTION

It is an object of the present invention to produce an effective white light-emitting organic device.

It is another object of this invention to provide an efficient and stable white light producing OLED device with simple structure and which can be reproduced in manufacturing environment.

It has been found quite unexpectedly that white light producing OLED devices with high luminance efficiency and operational stability can be obtained by doping yellow super rubrene derivative dopants 6,11-diphenyl-5,12-bis(4-(6-methyl-benzothiazol-2-yl)phenyl)naphthacene (DBzR), or 5,6,11,12-tetra(2-naphthyl)naphthacene (NR) in the NPB hole-transporting layer and distyrylamine derivatives blue dopant in the TBADN host light-emitting layer.

The object is achieved by an organic light-emitting diode (OLED) device which produces substantially white light, comprising:

a) an anode;

b) a hole-transporting layer disposed over the anode;

c) a blue light-emitting layer doped with a blue light-emitting compound disposed directly on the hole-transporting layer;

d) an electron-transporting layer disposed over the blue light-emitting layer;

e) a cathode disposed over the electron-transporting layer; and

f) the hole-transporting layer or electron-transporting layer, or both the hole-transporting layer and electron-transporting layer, being selectively doped with the following compound or derivatives thereof which emits light in the yellow region of the spectrum which corresponds to an entire layer or a partial portion of a layer in contact with the blue light-emitting layer:

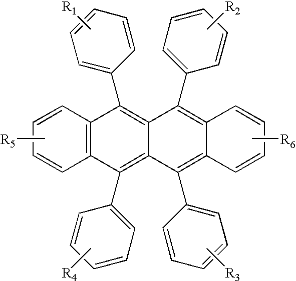

wherein R₁, R₂, R₃, R₄, R₅, R₆ represent one or more substituents on each ring where each substituent is individually selected from the following groups:

Group 1: hydrogen, or alkyl of from 1 to 24 carbon atoms;

Group 2: aryl or substituted aryl of from 5 to 20 carbon atoms;

Group 3: carbon atoms from 4 to 24 necessary to complete a fused aromatic ring of naphthyl, anthracenyl, phenanthryl, pyrenyl, or perylenyl;

Group 4: heteroaryl or substituted heteroaryl of from 5 to 24 carbon atoms such as thiazolyl, furyl, thienyl, pyridyl, quinolinyl or other heterocyclic systems, which may be bonded via a single bond, or may complete a fused heteroaromatic ring system;

Group 5: alkoxylamino, alkylamino, or arylamino of from 1 to 24 carbon atoms; or

Group 6: fluorine, chlorine, bromine or cyano,

except R₅ and R₆ do not form a fused ring, and at least one of the substituents R₁, R₂, R₃, and R₄ are substituted with a group other than hydrogen.

### ADVANTAGES

The following are features and advantages of the present invention.

A simplified OLED device for producing white light by having a yellow emitting super rubrene or derivatives thereof dopant 6,11-diphenyl-5,12-bis(4-(6-methyl-benzothiazol-2-yl)phenyl)naphthacene (DBzR), or 5,6,11,12-tetra(2-naphthyl)naphthacene (NR) in the hole-transporting layer, or the electron-transporting layer, or both.

High efficiency white OLEDs can be used to fabricate full-color devices using the substrate with the on chip color filters and integrated thin film transistors.

OLED devices made in accordance with the present invention eliminate the need for using shadow mask for making light-emitting layers in full-color OLED devices.

OLED devices made in accordance with the present invention can be produced with high reproducibility and consistently to provide high light efficiency.

These devices have high operational stability and also require low drive voltage.

### BRIEF DESCRIPTION OF THE DRAWINGS

FIG. 1 depicts a prior art organic light-emitting device;

FIG. 2 depicts another prior art organic light-emitting device;

FIG. 3 depicts a white light producing OLED device wherein the hole-transporting layer is doped with the super rubrene yellow dopant;

FIG. 4 depicts another structure of white light producing OLED device wherein hole-transporting layer is doped with super rubrene yellow dopant and has two sub layers;

FIG. 5 depicts a white light producing OLED device wherein the electron-transporting layer is doped with DBzR yellow dopant;

FIG. 6 depicts another structure of white light producing OLED device wherein both the hole-transporting layer and the electron-transporting layer are doped with super rubrene yellow dopant;

FIG. 7 depicts another structure of white light producing OLED device wherein both the hole-transporting layer and the electron-transporting layer are doped with super rubrene yellow dopant and has two sub layers;

FIG. 8 depicts a white light producing OLED device wherein the hole-transporting layer is doped with the super rubrene yellow dopant and has additional green-emitting layer;

FIG. 9 depicts another structure of white light producing OLED device wherein hole-transporting layer is doped with super rubrene yellow dopant and has two sub layers and has additional green-emitting layer;

FIG. 10 depicts a white light producing OLED device wherein the electron-transporting layer is doped with DBzR yellow dopant and has additional green-emitting layer;

FIG. 11 depicts another structure of white light producing OLED device wherein both the hole-transporting layer and the electron-transporting layer are doped with super rubrene yellow dopant and has additional green-emitting layer;

FIG. 12 depicts another structure of white light producing OLED device wherein both the hole-transporting layer and the electron-transporting layer are doped with super rubrene yellow dopant and has two sub layers. and has additional green-emitting layer;

FIG. 13 shows relative luminance change as a function of operation time for the three devices of Table 7; and

FIG. 14 shows relative luminance as a function of current density for four devices with several different combinations of the blue dopant and the yellow dopants I) rubrene with TBP II) NR with TBP, III) DBzR with TBP, IV) rubrene with B-1 V) NR with B-1, III) DBzR with B-1.

### DETAILED DESCRIPTION OF THE INVENTION

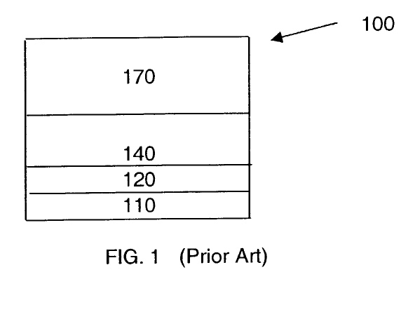

A conventional light-emitting layer of the organic OLED device comprises a luminescent or fluorescent material where electroluminescence is produced as a result of electron-hole pair recombination in this region. In the simplest construction, the device 100 as shown in FIG. 1 has a substrate 110 and a light-emitting layer 140 sandwiched between anode 120 and cathode 170. The light-emitting layer 140 is a pure material with a high luminescent efficiency. A well known material is tris(8-quinolinato) aluminum (Alq) which produces excellent green electroluminescence.

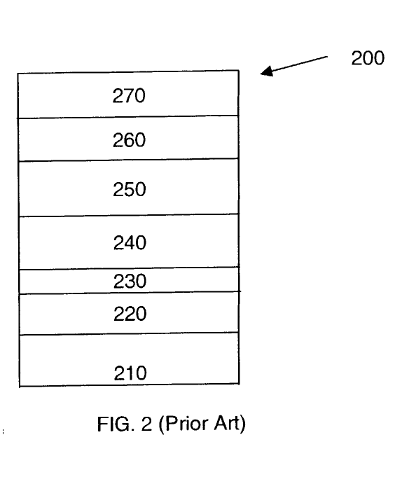

The simple structure can be modified to a three-layer structure (device 200) as shown in FIG. 2, in which an additional electroluminescent layer is introduced between the hole and electron-transporting layers to function primarily as the site for hole-electron recombination and thus electro-luminescence. In this respect, the functions of the individual organic layers are distinct and can therefore be optimized independently. Thus, the electroluminescent or recombination layer can be chosen to have a desirable OLED color as well as high luminance efficiency. Likewise, the electron and hole-transporting layers can be optimized primarily for the carrier transport property. It will be understood to those skilled in the art that the electron-transporting layer and the cathode can be made to be transparent thus facilitating illumination of the device through its top layer and not through the substrate.

Turning to FIG. 2, an organic light-emitting device 200 has a light-transmissive substrate 210 on which is disposed a light-transmissive anode 220. An organic light-emitting structure is formed between the anode 220 and a cathode 270. The organic light-emitting structure is comprised of, in sequence, an organic hole-transporting layer 240, an organic light-emitting layer 250, and an organic electron-transporting layer 260. Layer 230 is a hole-injecting layer. When an electrical potential difference (not shown) is applied between the anode 220 and the cathode 270, the cathode will inject electrons into the electron-transporting layer 240, and the electrons will migrate across layer 260 to the light-emitting layer 250. At the same time, holes will be injected from the anode 220 into the hole-transporting layer 240. The holes will migrate across layer 240 and recombine with electrons at or near a junction formed between the hole-transporting layer 240 and the light-emitting layer 250. When a migrating electron drops from its conduction band to a valance band in filling a hole, energy is released as light, and which is emitted through the light-transmissive anode 220 and substrate 210.

The organic OLED devices can be viewed as a diode, which is forward biased when the anode is at a higher potential than the cathode. The anode and cathode of the organic OLED device can each take any convenient conventional form, such as any of the various forms disclosed by Tang et al. in U.S. Pat. No. 4,885,211. Operating voltage can be substantially reduced when using a low-work function cathode and a high-work function anode. The preferred cathodes are those constructed of a combination of a metal having a work function less than 4.0 eV and one other metal, preferably a metal having a work function greater than 4.0 eV. The Mg:Ag of Tang et al. U.S. Pat. No. 4,885,211 constitutes one preferred cathode construction. The Al:Mg cathodes of Van Slyke et al. U.S. Pat. No. 5,059,062 is another preferred cathode construction. Hung et al. in U.S. Pat. No. 5,776,622 has disclosed the use of a LiF/Al bilayer to enhanced electron injection in organic OLED devices. Cathodes made of either Mg:Ag, Al:Mg or LiF/Al are opaque and displays cannot be viewed through the cathode. Recently, series of publications Gu et al. in APL 68, 2606 (1996); Burrows et al., J. Appl. Phys. 87, 3080 (2000); Parthasarathy et al. APL 72, 2138 9198); Parthasarathy et al. APL 76, 2128 (2000), and Hung et al. APL, 3209 (1999) have disclosed transparent cathode. Cathode based on the combination of thin semitransparent metal (˜100 A) and indium-tin-oxide (ITO) on top of the metal. An organic layer of copper phthalocyanine (CuPc) also replaced thin metal.

Conventionally, anodes 220 is formed of a conductive and transparent oxide. Indium tin oxide has been widely used as the anode contact because of its transparency, good conductivity, and high-work function.

In a preferred embodiment, an anode 220 can be modified with a hole-injecting layer 230. The hole-injecting material can serve to improve the film formation property of subsequent organic layers and to facilitate injection of holes into the hole-transporting layer. Suitable materials for use in the hole-injecting layer include, but are not limited to, porphyrinic compounds such as CuPC as described in U.S. Pat. No. 4,720,432, and plasma-deposited fluorocarbon polymers as described in U.S. Pat. No. 6,208,075. and some aromatic amines, for example, m-MTDATA (4,4′,4″-tris[(3-methylphenyl)phenylamino]triphenylamine). Alternative hole-injecting materials reportedly useful in organic EL devices are described in EP 0 891 121 A1 and EP 1 029 909 A1. An example of material in such a hole-injecting layer are the fluorocarbons disclosed by Hung U.S. patent application Ser. No. 09/186,829 filed Nov. 5, 1998, the disclosure of which is incorporated herein by reference.

The OLED device of this invention is typically provided over a supporting substrate 210 where either the cathode or anode can be in contact with the substrate. The electrode in contact with the substrate is conveniently referred to as the bottom electrode. Conventionally, the bottom electrode is the anode, but this invention is not limited to that configuration. The substrate can either be light-transmissive or opaque, depending on the intended direction of light emission. The light-transmissive property is desirable for viewing the EL emission through the substrate. Transparent glass or plastic is commonly employed in such cases. For applications where the EL emission is viewed through the top electrode, the transmissive characteristic of the bottom support is immaterial, and therefore can be light-transmissive, light absorbing or light reflective. Substrates for use in this case include, but are not limited to, glass, plastic, semiconductor materials, silicon, ceramics, circuit board materials, and polished metal surface. Of course, it is necessary to provide in these device configurations a light-transparent top electrode.

The white OLED emission can be used to prepare a full-color device using red, green, and blue (RGB) color filters. The RGB filters may be deposited on the substrate (when light transmission is through the substrate), incorporated into the substrate, or deposited over the top electrode (when light transmission is through the top electrode). When depositing a RGB filter array over the top electrode, a buffer layer may be used to protect the top electrode. The buffer layer may comprise inorganic materials, for example, silicon oxides and nitrides, or organic materials, for example, polymers, or multiple layers of inorganic and organic materials. Methods for providing RGB filter arrays are well known in the art. Lithographic means, inkjet printing, and laser thermal transfer are just a few of the methods RGB filters may be provided.

This technique of producing of full-color display using white light plus RGB filters has several advantages over the precision shadow masking technology used for producing the full-colors. This technique does not require precision alignment, is low cost and easy to manufacture. The substrate itself contains thin film transistors to address the individual pixels. U.S. Pat. Nos. 5,550,066 and 5,684,365 to Ching and Hseih describe the addressing methods of the TFT substrates.

The hole-transporting layer contains at least one hole-transporting compound such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. U.S. Pat. No. 3,180,730. Other suitable triarylamines substituted with one or more vinyl radicals and/or comprising at least one active hydrogen containing group are disclosed by Brantley et al. U.S. Pat. Nos. 3,567,450 and 3,658,520.

A more preferred class of aromatic tertiary amines are those which include at least two aromatic tertiary amine moieties as described in U.S. Pat. Nos. 4,720,432 and 5,061,569. The hole-transporting layer can be formed of a single or a mixture of aromatic tertiary amine compounds. Illustrative of useful aromatic tertiary amines is the following:

1,1-Bis(4-di-p-tolylaminophenyl)cyclohexane

1,1-Bis(4-di-p-tolylaminophenyl)-4-phenylcyclohexane

4,4′-Bis(diphenylamino)quadriphenyl

Bis(4-dimethylamino-2-methylphenyl)-phenylmethane N,N,N-Tri(p-tolyl)amine

4-(di-p-tolylamino)-4′-[4(di-p-tolylamino)-styryl]stilbene

N,N,N′,N′-Tetra-p-tolyl-4-4′-diaminobiphenyl

N,N,N′,N′-Tetraphenyl-4,4′-diaminobiphenyl

N,N,N′,N′-tetra-1-naphthyl-4,4′-diaminobiphenyl

N,N,N′,N ′-tetra-2-naphthyl-4,4′-diaminobiphenyl

N-Phenylcarbazole

4,4′-Bis[N-(1-naphthyl)-N-phenylamino]biphenyl (NPB)

4,4′-Bis[N-(1-naphthyl)-N-(2-naphthyl)amino]biphenyl (TNB)

4,4″-Bis[N-(1-naphthyl)-N-phenylamino]p-terphenyl

4,4′-Bis[N-(2-naphthyl)-N-phenylamino]biphenyl

4,4′-Bis[N-(3-acenaphthenyl)-N-phenylamino]biphenyl

1,5-Bis[N-(1-naphthyl)-N-phenylamino]naphthalene

4,4′-Bis[N-(9-anthryl)-N-phenylamino]biphenyl

4,4″-Bis[N-(1-anthryl)-N-phenylamino]-p-terphenyl

4,4′-Bis[N-(2-phenantheryl)-N-phenylamino]biphenyl

4,4′-Bis[N-(8-fluoranthenyl)-N-phenylamino]biphenyl

4,4′-Bis[N-(2-pyrenyl)-N-phenylamino]biphenyl

4,4′-Bis[N-(2-naphthacenyl)-N-phenylamino]biphenyl

4,4′-Bis[N-(2-perylenyl)-N-phenylamino]biphenyl

4,4′-Bis[N-(1-coronenyl)-N-phenylamino]biphenyl

2,6-Bis(di-p-tolylamino)naphthalene

2,6-Bis[di-(1-naphthyl)amino]naphthalene

2,6-Bis[N-(1-naphthyl)-N-(2-naphthyl)amino]naphthalene

N,N,N′,N′-Tetra(2-naphthyl)-4,4″-diamino-p-terphenyl

4,4′-Bis {N-phenyl-N-[4-(1-naphthyl)-phenyl]amino}biphenyl

4,4′-Bis[N-phenyl-N-(2-pyrenyl)amino]biphenyl

2,6-Bis[N,N-di(2-naphthyl)amine]fluorene

1,5-Bis[N-(1-naphthyl)-N-phenylamino]naphthalene

4,4′,4″-tris[(3-methylphenyl)phenylamino]triphenylamine (MTDATA)

4,4′-Bis[N-(3-methylphenyl)-N-phenylamino]biphenyl (TPD)

Another class of useful hole-transporting materials includes polycyclic aromatic compounds as described in EP 1 009 041. Tertiary aromatic amines with more than two amine groups may be used including oligomeric materials. In addition, polymeric hole-transporting materials can be used such as poly(N-vinylcarbazole) (PVK), polythiophenes, polypyrrole, polyaniline, and copolymers such as poly(3,4-ethylenedioxythiophene)/poly(4-styrenesulfonate) also called PEDOT/PSS.

Preferred materials for use in forming the electron-transporting layer of the organic OLED devices of this invention are metal chelated oxinoid compounds, including chelates of oxine itself (also commonly referred to as 8-quinolinol or 8-hydroxyquinoline) as disclosed in U.S. Pat. No. 4,885,211. Such compounds exhibit both high levels of performance and are readily fabricated in the form of thin layers. Some examples of useful electron-transporting materials are:

CO-1: Aluminum trisoxine [alias, tris(8-quinolinolato)aluminum(III)]

CO-2: Magnesium bisoxine [alias, bis(8-quinolinolato)magnesium(II)]

CO-3: Bis[benzo{f}-8-quinolinolato]zinc (II)

CO-4: Bis(2-methyl-8-quinolinolato)aluminum(III)-μ-oxo-bis(2-methyl-8-quinolinolato) aluminum(III)

CO-5: Indium trisoxine [alias, tris(8-quinolinolato)indium]

CO-6: Aluminum tris(5-methyloxine) [alias, tris(5-methyl-8-quinolinolato) aluminum(III)]

CO-7: Lithium oxine [alias, (8-quinolinolato)lithium(I)]

CO-8: Gallium oxine [alias, tris(8-quinolinolato)gallium(III)]

CO-9: Zirconium oxine [alias, tetra(8-quinolinolato)zirconium(IV)]

Other electron-transporting materials include various butadiene derivatives as disclosed in U.S. Pat. No. 4,356,429 and various heterocyclic optical brighteners as described in U.S. Pat. No. 4,539,507. Benzazoles and triazines are also useful electron-transporting materials.

A preferred embodiment of the luminescent layer consists of a host material doped with fluorescent dyes. Using this method, highly efficient EL devices can be constructed. Simultaneously, the color of the EL devices can be tuned by using fluorescent dyes of different emission wavelengths in a common host material. Tang et al. in commonly assigned U.S. Pat. No. 4,769,292 has described this dopant scheme in considerable details for EL devices using Alq as the host material.

Shi et al. in commonly assigned U.S. Pat. No. 5,935,721 has described this dopant scheme in considerable details for the blue emitting OLED devices using 9,10-di-(2-naphthyl)anthracene (ADN) derivatives as the host material.

Derivatives of 9,10-di-(2-naphthyl)anthracene (Formula 1) constitute one class of useful hosts capable of supporting electroluminescence, and are particularly suitable for light emission of wavelengths longer than 400 nm, e.g., blue, green, yellow, orange, or red.

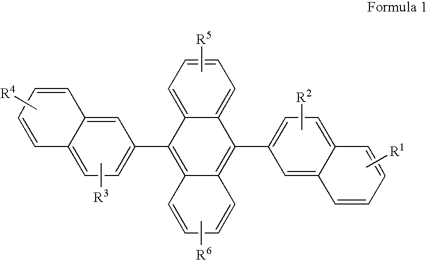

wherein R₁, R₂, R₃, R₄, R₅, R₆ represent one or more substituents on each ring where each substituent is individually selected from the following groups:

Group 1: hydrogen, or alkyl of from 1 to 24 carbon atoms;

Group 2: aryl or substituted aryl of from 5 to 20 carbon atoms;

Group 3: carbon atoms from 4 to 24 necessary to complete a fused aromatic ring of naphthyl, anthracenyl; phenanthryl, pyrenyl, or perylenyl;

Group 4: heteroaryl or substituted heteroaryl of from 5 to 24 carbon atoms such as thiazolyl, furyl, thienyl, pyridyl, quinolinyl or other heterocyclic systems, which may be bonded via a single bond, or may complete a fused heteroaromatic ring system;

Group 5: alkoxylamino, alkylamino, or arylamino of from 1 to 24 carbon atoms; or

Group 6: fluorine, chlorine, bromine or cyano,

except R₅ and R₆ do not form a fused ring; and at least one of the substituents R₁, R₂, R₃, and R₄ are substituted with a group other than hydrogen.

It is desirable that these substitutions should yield a shift to lower emission energy relative to rubrene. Preferred groups for substitution on R₁-R₄ are Groups 3 and 4.

Illustrative examples include 9,10-di-(2-naphthyl)anthracene (ADN) and 2-t-butyl-9,10-di-(2-naphthyl)anthracene (TBADN). Other anthracene derivatives can be useful as a host in the LEL, such as diphenylanthracene and its derivatives, as described in U.S. Pat. No. 5,927,247. Styrylarylene derivatives as described in U.S. Pat. No. 5,121,029 and JP 08333569 are also useful hosts for blue emission. For example, 9,10-bis[4-(2,2-diphenylethenyl)phenyl]anthracene and 4,4′-Bis(2,2-diphenylethenyl)-1,1′-biphenyl (DPVBi) are useful hosts for blue emission.

Many blue fluorescent dopants are known in the art, and are contemplated for use in the practice of this invention. Particularly useful classes of blue-emitting dopants include perylene and its derivatives such as 2,5,8,11-tetra-tert-butyl perylene (TBP), and distyrylamine derivatives as described in U.S. Pat. No. 5,121,029, such as B 1 (structure shown below)

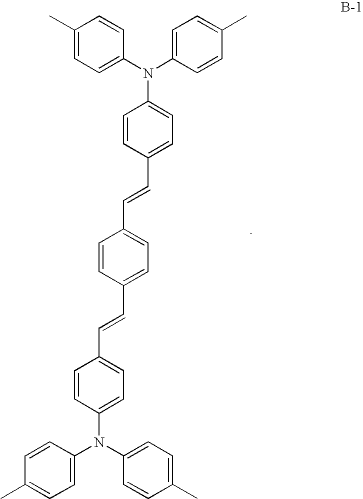

Another useful class of blue-emitting dopants is represented by Formula 2 and is described in commonly assigned U.S. patent application Ser. No. 10/183,242 filed Jun. 27, 2002 by Benjamin P. Hoag et al., entitled “Organic Element for Electroluminescent Devices”; the disclosure of which is incorporated herein.

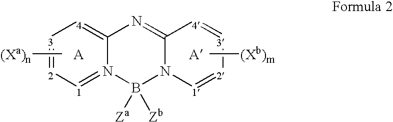

Formula 2

wherein:

A and A′ represent independent azine ring systems corresponding to 6-membered aromatic ring systems containing at least one nitrogen;

each X^{a} and X^{b} is an independently selected substituent, two of which may join to form a fused ring to A or A′;

m and n are independently 0 to 4;

Z^{a} and Z^{b} are independently selected substituents; and

1, 2, 3, 4, 1′, 2′, 3′, and 4′ are independently selected as either carbon or nitrogen atoms.

Desirably, the azine rings are either quinolinyl or isoquinolinyl rings such that 1, 2, 3, 4, 1′, 2′, 3′, and 4′ are all carbon; m and n are equal to or greater than 2; and X^{a} and X^{b} represent at least two carbon substituents which join to form an aromatic ring. Desirably, Z^{a} and Z^{b} are fluorine atoms.

Preferred embodiments further include devices where the two fused ring systems are quinoline or isoquinoline systems; the aryl or heteroaryl substituent is a phenyl group; there are present at least two X^{a} groups and two X^{b} groups which join to form a 6-6 fused ring, the fused ring systems are fused at the 1-2, 3-4, 1′-2′, or 3′-4′ positions, respectively; one or both of the fused rings is substituted by a phenyl group; and where the dopant is depicted in Formula 3, 4, or 5.

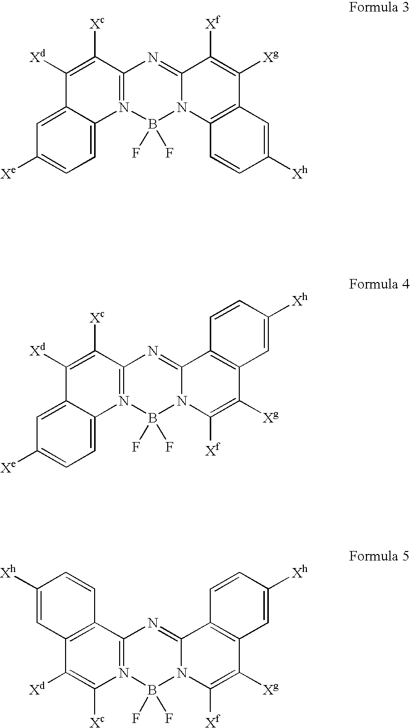

wherein each X^{c}, X^{d}, X^{e}, X^{f}, X^{g}, and X^{h} is hydrogen or an independently selected substituent, one of which must be an aryl or heteroaryl group.

Desirably, the azine rings are either quinolinyl or isoquinolinyl rings such that 1, 2, 3, 4, 1′, 2′, 3′, and 4′ are all carbon; m and n are equal to or greater than 2; and X^{a} and X^{b} represent at least two carbon substituents which join to form an aromatic ring, and one is an aryl or substituted aryl group. Desirably, Z^{a} and Z^{b} are fluorine atoms.

Illustrative, non-limiting examples of boron compounds complexed by two ring nitrogens of a deprotonated bis(azinyl)amine ligand, wherein the two ring nitrogens are members of different 6,6 fused ring systems in which at least one of the systems contains an aryl or heteroaryl substituent, useful in the present invention are the following:

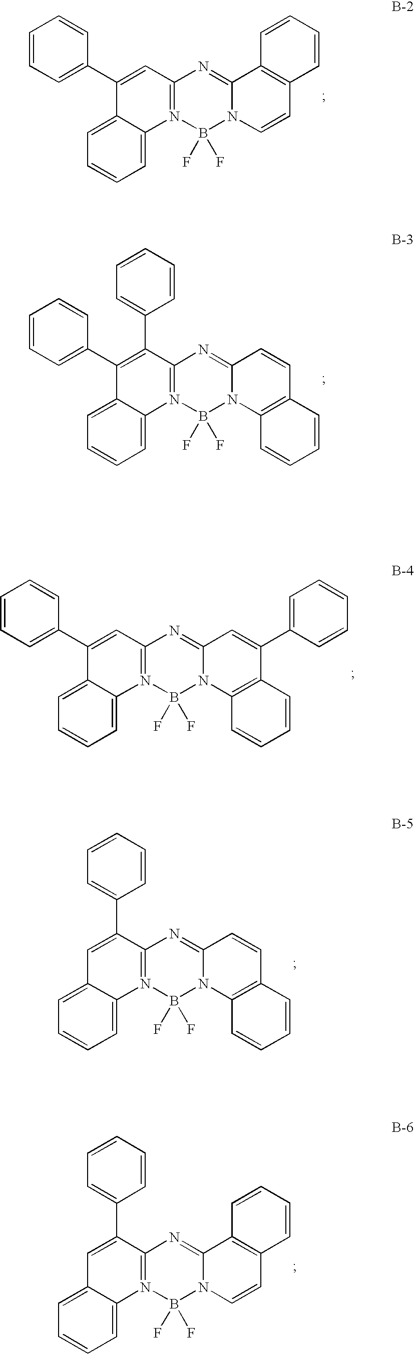

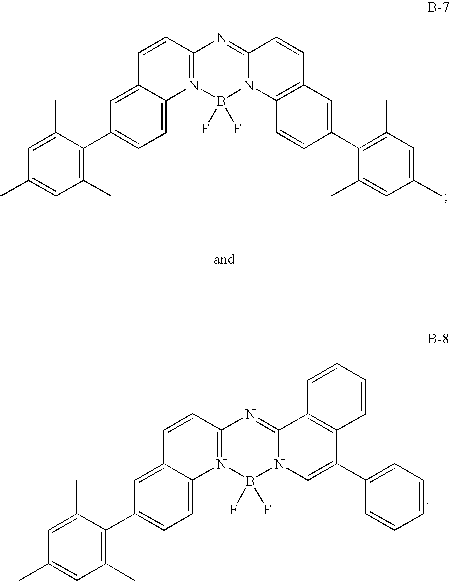

Preferred materials for uses as a yellow-emitting dopant in the hole-transporting or electron-transporting layers are those represented by Formula 6.

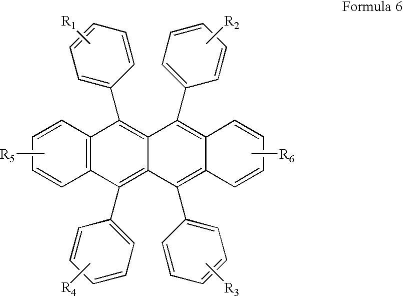

wherein R₁, R₂, R₃, and R₄ represent one or more substituents on each ring where each substituent is individually selected from the following groups:

Group 1: hydrogen, or alkyl of from 1 to 24 carbon atoms;

Group 2: aryl or substituted aryl of from 5 to 20 carbon atoms;

Group 3: carbon atoms from 4 to 24 necessary to complete a fused aromatic ring of naphthyl, anthracenyl; phenanthryl, pyrenyl, or perylenyl;

Group 4: heteroaryl or substituted heteroaryl of from 5 to 24 carbon atoms such as thiazolyl, furyl, thienyl, pyridyl, quinolinyl or other heterocyclic systems, which may be bonded via a single bond, or may complete a fused heteroaromatic ring system;

Group 5: alkoxylamino, alkylamino, or arylamino of from 1 to 24 carbon atoms; or

Group 6: fluorine, chlorine, bromine or cyano.

R₅ and R₆ are defined in the same way as R₁-R₄ except that they do not form a fused ring.

Further, at least one of R₁-R₄ must be substituted with a group other than hydrogen. It is desirable that these substitutions should yield a shift to lower emission energy relative to rubrene. Preferred groups for substitution on R₁-R₄ are Groups 3 and 4.

In order to facilitate an understanding of the present invention and to simplify the following discussion, all of the yellow light-emitting dopant compounds defined above will sometimes be referred to as “super rubrene”.

Examples of particularly useful super rubrene dopants include include 6,11-diphenyl-5,12-bis(4-(6-methyl-benzothiazol-2-yl)phenyl)naphthacene (DBzR) and 5,6,11,12-tetra(2-naphthyl)naphthacene (NR), the formulas of which are shown below:

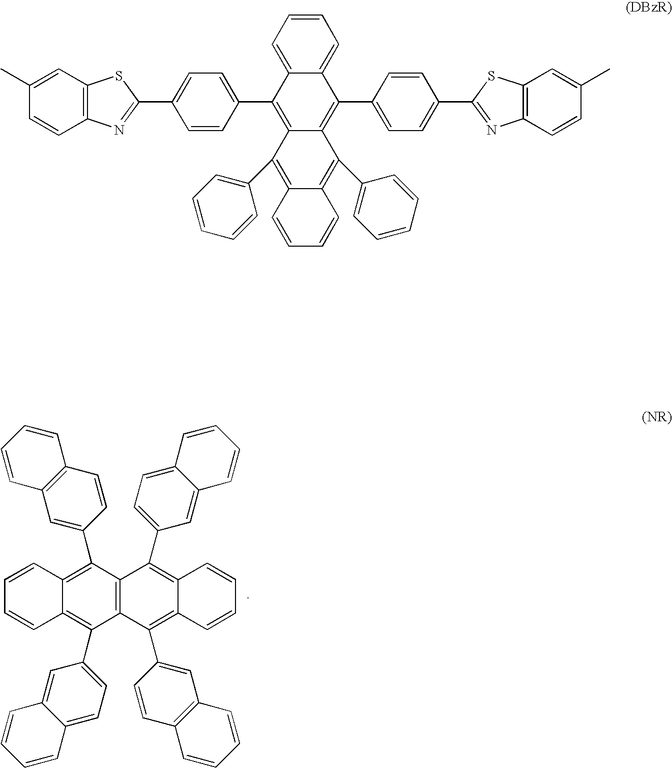

Coumarins represent a useful class of green-emitting dopants as described by Tang et al. in U.S. Pat. Nos. 4,769,292 and 6,020,078. Examples of useful green-emitting coumarins include C545T and C545TB. Quinacridones represent another useful class of green-emitting dopants. Useful quinacridones are described in U.S. Pat. No. 5,593,788, publication JP 09-13026A, and commonly assigned U.S. patent application Ser. No. 10/184,356 filed Jun. 27, 2002 by Lelia Cosimbescu, entitled “Device Containing Green Organic Light-Emitting Diode”, the disclosure of which is incorporated herein.

Examples of particularly useful green-emitting quinacridones are shown below:

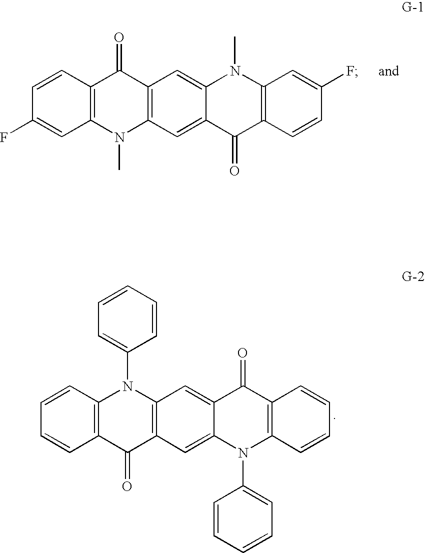

Another useful class of green-emitting dopants is represented by Formula 7 below.

Compounds useful in the invention are suitably represented by Formula 7.

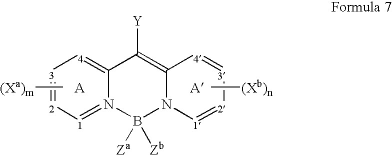

wherein:

A and A′ represent independent azine ring systems corresponding to 6-membered aromatic ring systems containing at least one nitrogen;

each X^{a} and X^{b} is an independently selected substituent, two of which may join to form a fused ring to A or A′;

m and n are independently 0 to 4;

Y is H or a substituent;

Z^{a} and Z^{b} are independently selected substituents; and

1, 2, 3, 4, 1′, 2′, 3′, and 4′ are independently selected as either carbon or nitrogen atoms.

In the device, 1, 2, 3, 4, 1′, 2′, 3′, and 4′ are conveniently all carbon atoms. The device may desirably contain at least one or both of ring A or A′ that contains substituents joined to form a fused ring. In one useful embodiment, there is present at least one X^{a} or X^{b} group selected from the group consisting of halide and alkyl, aryl, alkoxy, and aryloxy groups. In another embodiment, there is present a Z^{a} and Z^{b} group independently selected from the group consisting of fluorine and alkyl, aryl, alkoxy and aryloxy groups. A desirable embodiment is where Z^{a} and Z^{b} are F. Y is suitably hydrogen or a substituent such as an alkyl, aryl, or heterocyclic group.

The emission wavelength of these compounds may be adjusted to some extent by appropriate substitution around the central bis(azinyl)methene boron group to meet a color aim, namely green. Some examples of useful formulas follow:

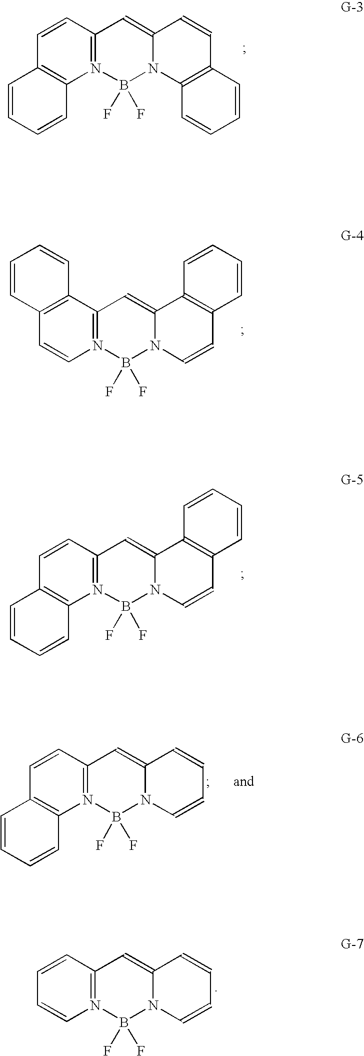

The invention and its advantages are further illustrated by the specific examples that follow. The term “percentage” indicates the volume percentage (or a thickness ration as measured on the thin film thickness monitor) of a particular dopant with respect to the host material.

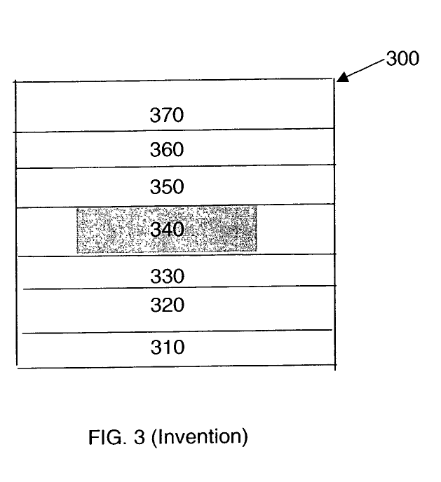

FIGS. 3-14 shows schematics of the white light producing OLED device structure prepared of the present invention and graphs of various parameters of their operations. The invention and its advantages are further illustrated by the specific examples that follow.

Turning to FIG. 3, an organic white light-emitting device 300 has a light-transmissive substrate 310 on which is disposed a light-transmissive anode 320. An organic white light-emitting structure 300 is formed between the anode 320 and a cathode 370. The organic light-emitting structure is comprised of, in sequence, a hole-injecting layer 330, and an organic hole-transporting layer 340, which is doped with super rubrene yellow dopants. An organic light-emitting layer 350 is blue light-emitting layer comprising TBADN host and B-1 dopant. An organic electron-transporting layer 360 is made of Alq.

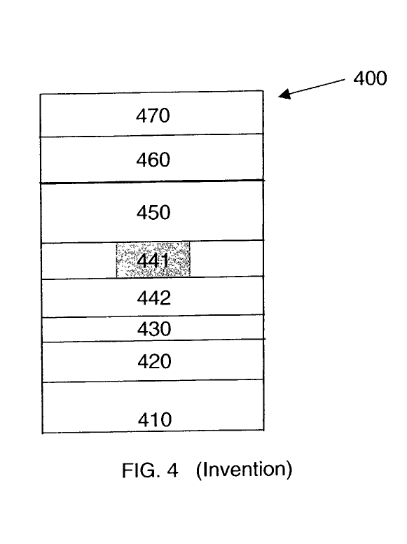

FIG. 4 depicts an organic white light-emitting device 400 which is similar to that shown in FIG. 3, except that the organic hole-transporting layer comprises two sub layers, layers 441 and layer 442. Layer 442 is made of undoped NPB and the layer 441, which is adjacent to the blue light-emitting layer 450, is doped with super rubrene yellow dopant. Other layers of the structure 400 are substrate 410, anode 420, hole-injecting layer 430, electron-transporting layer 460, and cathode 470.

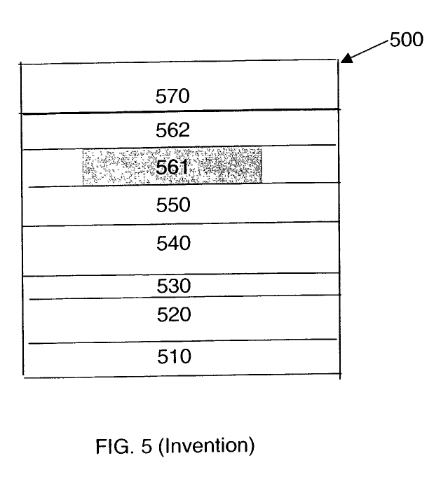

FIG. 5 depicts an organic white light-emitting device 500. The electron-transporting layer comprises two sub layers, 561 and 562. Electron-transporting sub layer 561 is doped with the super rubrene yellow dopant. Electron-transporting sub layer 562 is not doped with a light-emitting dopant. The blue light-emitting layer 550 comprises TBADN host and B-1 blue dopant. Other layers of the structure 500 are substrate 510, anode 520, hole-injecting layer 530, and cathode 570.

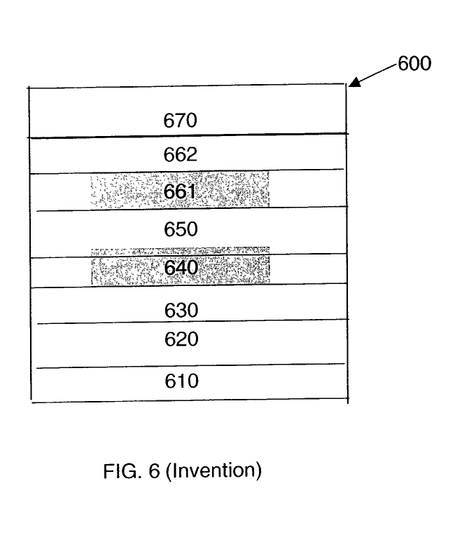

FIG. 6 depicts an organic white light-emitting device 600, which is a combination of the structure 300 and structure 500. The hole-transporting layer 640 is doped with a super rubrene yellow dopant. The electron-transporting layer comprises two electron-transporting sub layers, 661 and 662, and sub layer 661 is doped with a super rubrene yellow dopant. The blue light-emitting layer 650 is made of TBADN host with B-1 blue dopant. This device shows very high stability and high luminance efficiency. Other layers of the structure 600 are substrate 610, anode 620, hole-injecting layer 630, electron-transporting layer 662, and cathode 670.

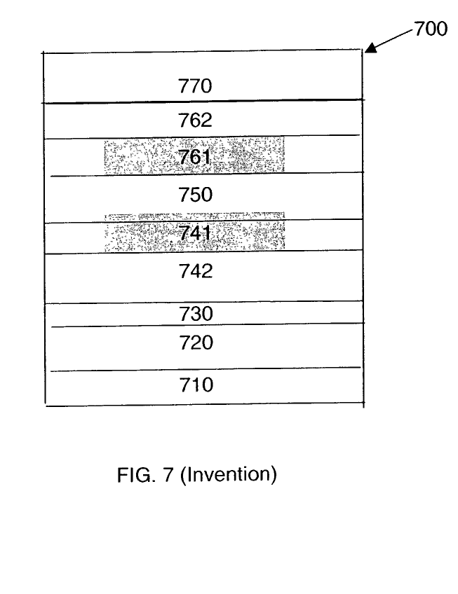

FIG. 7 depicts an organic white light-emitting device 700 which is similar to that shown in FIG. 6, except that the organic hole-transporting layer consists of two sub layers, sub layers 741 and layer 742. Layer 742 is made of undoped NPB, and the layer 741 adjacent to the blue light-emitting layer 750 is doped with a super rubrene yellow dopant. The electron-transporting layer comprises two sub layers, sub layers 761 and 762. Electron-transporting sub layer 761 is adjacent to the blue light-emitting layer 750, and is also doped with super rubrene. Electron-transporting sub layer 762 is not doped with a light-emitting dopant. Other layers of the structure 700 are substrate 710, anode 720, hole-injecting layer 730, and cathode 770.

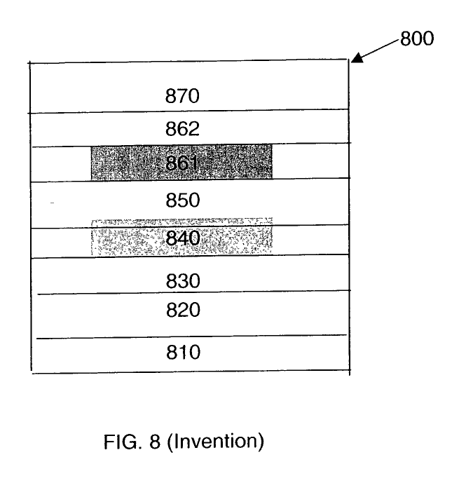

FIG. 8 depicts an organic white light-emitting device 800 that is similar to that shown in FIG. 3, except that the electron-transporting layer comprises two sub layers, 861 and 862. Electron-transporting sub layer 861 comprises a green-emitting dopant such as C545T, CFDMQA and DPQA, and layer 861 is adjacent to the blue light-emitting layer 850. Electron-transporting sub layer 862 is not doped with a light-emitting dopant. The blue light-emitting layer is 850 and consists of TBADN host and B-1 blue dopant. The hole-transporting layer 840 is doped with super rubrene yellow dopant. Other layers of the structure 800 are substrate 810, anode 820, hole-injecting layer 830, and cathode 870.

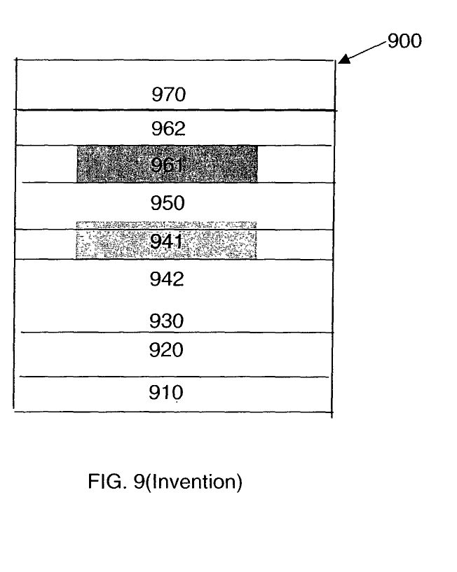

FIG. 9 depicts an organic white light-emitting device 900 which is similar to that shown in FIG. 8, except that the organic hole-transporting layer comprises two sub layers, 941 and 942. Hole-transporting sub layer 942 is made of undoped NPB, and the layer 941 adjacent to the blue light-emitting layer 950 is doped with super rubrene yellow dopant. The electron-transporting layer comprises two sub layers, 961 and 962. The electron-transporting sub layer 961 is adjacent to the blue light-emitting layer 950, and comprises Alq doped with green dopants such as C545T, CFDMQA and DPQA dopants. Electron-transporting sub layer 962 is not doped with a light-emitting dopant. The blue light-emitting layer is 950 and consists of TBADN host and B-1 blue dopant. Other layers of the structure 900 are substrate 910, anode 920, hole-injecting layer 930, and cathode 970.

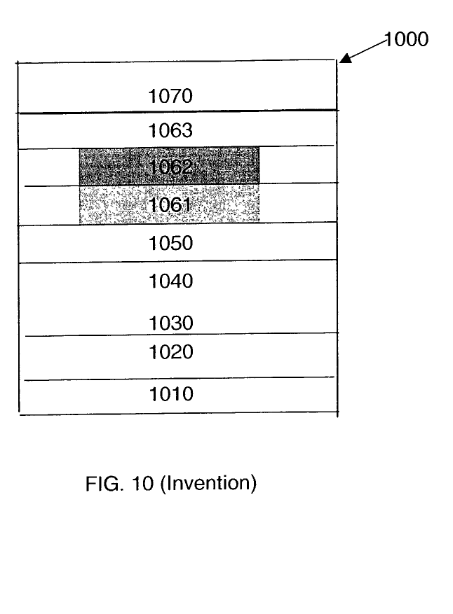

FIG. 10 depicts an organic white light-emitting device 1000. Here, the electron-transporting layer comprises three sub layers, 1061, 1062, and 1063. The electron-transporting sub layer 1061 is doped with the super rubrene yellow dopant, and this layer is adjacent to the blue light-emitting layer 1050. Electron-transporting sub layer 1062 comprises a green-emitting dopant such as C545T, CFDMQA or DPQA. Electron-transporting sub layer 1063 is not doped with a light-emitting dopant. The blue light-emitting layer 1050 can comprise TBADN host and B-1 blue dopant. Other layers of the structure 1000 are substrate 1010, anode 1020, hole-injecting layer 1030, hole-transporting layer 1040, and cathode 1070.

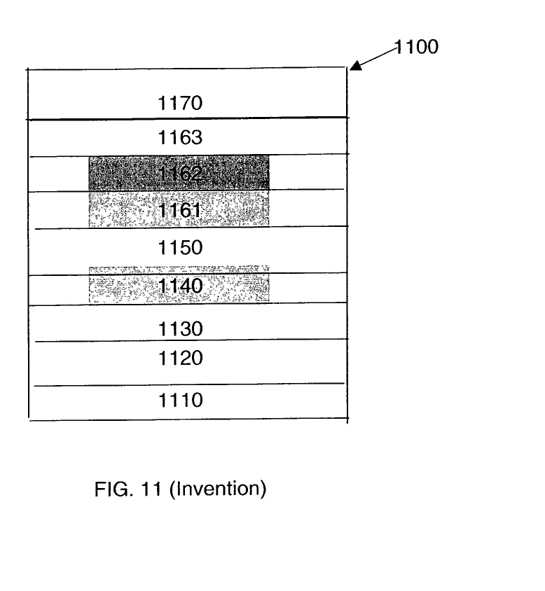

FIG. 11 depicts an organic white light-emitting device 1100. Here, the electron-transporting layer comprises three sub layers, 1161, 1162, and 1163. The electron-transporting sub layer 1161 is doped with the super rubrene yellow dopant, and this layer is adjacent to the blue light-emitting layer 1150. Electron-transporting sub layer 1162 comprises a green-emitting dopant such as C545T, CFDMQA or DPQA. Electron-transporting sub layer 1163 is not doped with a light-emitting dopant. The blue light-emitting layer 1150 can comprise TBADN host and B-1 blue dopant. The hole-transporting layer 1140 is both doped with a super rubrene yellow dopant. This device shows very high stability, high luminance efficiency, and good spectral radiance for all colors after the R, G, B color filters. Other layers of the structure 1100 are substrate 1110, anode 1120, hole-injecting layer 1130, and cathode 1170.

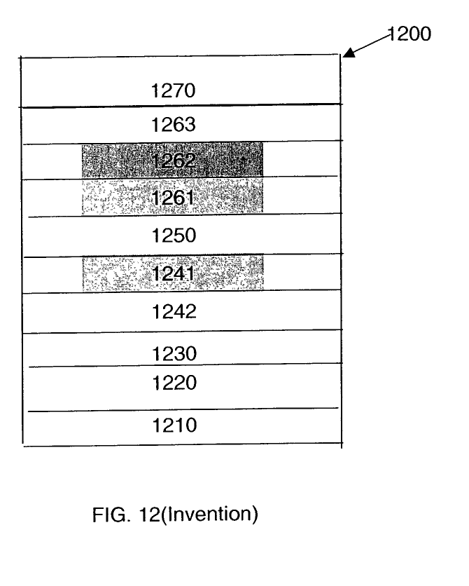

FIG. 12 depicts an organic white light-emitting device 1200. Here, the electron-transporting layer comprises three sub layers, 1261, 1262, and 1263. The electron-transporting sub layer 1261 is doped with the super rubrene yellow dopant, and this layer is adjacent to the blue light-emitting layer 1250. Electron-transporting sub layer 1262 comprises a green-emitting dopant such as C545T, CFDMQA or DPQA. Electron-transporting sub layer 1263 is not doped with a light-emitting dopant. The blue light-emitting layer 1250 can comprise TBADN host and B-1 blue dopant. The hole-transporting layer comprises two sub layers, 1241 and 1242. Hole-transporting sub layer 1241 is undoped NPB. Hole-transporting sub layer 1242 is adjacent to blue light-emitting layer 1250, and is doped with a super rubrene yellow dopant. Other layers of the structure 1200 are substrate 1210, anode 1220, hole-injecting layer 1230, and cathode 1170.

The invention and its advantages are further illustrated by the specific following examples.

### DEVICES EXAMPLES 1 TO 6

### Table 1

An OLED device was constructed in the following manner.

Substrates coated with 80 nm ITO were sequentially ultrasonicated in a commercial detergent, rinsed in deionized water, and degreased in toluene vapor. These substrates were treated with an oxygen plasma for about one minute and coated with one nm fluorocarbon layer by plasma assisted deposition of CHF₃. The same procedure was used for preparing all other devices described in this invention.

These substrates were loaded into a deposition chamber for organic layers and cathode depositions.

Device of Example 1 was prepared by sequential deposition of 150 nm NPB hole-transporting layer (HTL), 20 nm blue light-emitting layer (LEL) comprising TBADN host with 2% TBP blue dopant, 37.5 nm Alq electron-transporting layer (ETL), and then 0.5 nm LiF and 200 nm Al as a part of cathode. The above sequence completed the deposition of the OLED device.

The OLED device was then hermetically packaged in a dry glove box filled with nitrogen for protection against ambient environment. The ITO patterned substrates used for preparing these OLED devices contained several test patterns. Each of the devices was tested for current voltage characteristics and the electroluminescence yield.

Devices of Examples 2 to 6 were prepared following structure of OLED 300 as shown in FIG. 3. NPB hole-transporting layer of 150 nm thickness was doped with varying amount of rubrene concentrations varying from 1% to 5%. It was found that the device of Example 1 has emission in the blue region of the electromagnetic spectrum, while the emission from devices of Examples 2 to 6 is either white or bluish white or yellowish-white. Table 1 shows luminance, color coordinates, and drive voltage for devices 1 to 6 prepared using rubrene yellow dopant in the hole-transporting layer, and TBP dopant in the TBADN blue light-emitting layer. The maximum luminance efficiency obtained from the devices of Examples 2 to 6 was about 3.9 cd/A.

TABLE 1
White devices characteristics using Rubrene doping into HTL with TBADN + TBP as a Blue LEL

| | | HTL layer | Rubrene doping | | | | Drive | | EL peak | | |
|---|---|---|---|---|---|---|---|---|---|---|---|
| Device | Example | thickness | into 150 nm | Blue Light-emitting | | | Volt. | Luminance | pos | | |
| Example # | type | (nm) | HTL layer | layer | ETL layer | Cathode | (V) | Yield (cd/A) | (nm) | ClEx | ClEy |
| 1 | Comparison | 150 nm | 0 | 20 nm TBADN + 2% | 35 nm Alq | 200 nm | 7.4 | 3.1 | 464 | 0.15 | 0.25 |
| | | | | TBP | | MgAg | | | | | |
| 2 | Comparison | 150 nm | 1% | 20 nm TBADN + 2% | 35 nm Alq | 200 nm | 7.0 | 3.3 | 464 | 0.24 | 0.31 |
| | | | | TBP | | MgAg | | | | | |
| 3 | Comparison | 150 nm | 2% | 20 nm TBADN + 2% | 35 nm Alq | 200 nm | 7.0 | 3.9 | 464 | 0.31 | 0.36 |
| | | | | TBP | | MgAg | | | | | |
| 4 | Comparison | 150 nm | 3% | 20 nm TBADN + 2% | 35 nm Alq | 200 nm | 7.1 | 3.9 | 464 | 0.34 | 0.38 |
| | | | | TBP | | MgAg | | | | | |
| 5 | Comparison | 150 nm | 4% | 20 nm TBADN + 2% | 35 nm Alq | 200 nm | 7.0 | 3.8 | 464 | 0.36 | 0.40 |
| | | | | TBP | | MgAg | | | | | |
| 6 | Comparison | 150 nm | 5% | 20 nm TBADN + 2% | 35 nm Alq | 200 nm | 7.1 | 3.8 | 464 | 0.38 | 0.41 |
| | | | | TBP | | MgAg | | | | | |

### DEVICE EXAMPLES 7 TO 12

### Table 2

Devices of Examples 7 to 12 were prepared following structure of OLED 300 as shown in FIG. 3. NPB hole-transporting layer of 150 nm thickness was doped with varying amount of super rubrene NR compound with concentrations varying from 0% to 5%. It was found that the device of Example 7 has emission in the blue region of the electromagnetic spectrum, while the emission from devices of Example 8 to 12 is either white or bluish white or yellowish-white. Table 2 shows luminance, color coordinates, and drive voltage for devices 1 to 6 prepared using super rubrene NR as yellow dopant in the hole-transporting layer and TBP dopant in the TBADN blue light-emitting layer. The maximum luminance efficiency obtained from the devices of Examples 7 to 12 was about 4.6 cd/A. Table 1 shows that the devices using super rubrene NR generally have higher luminance yield.

TABLE 2
White device characteristics using NR doping into HTL with TBADN + TBP as a Blue EML

| | | | NR doping into | | | | | | | |
|---|---|---|---|---|---|---|---|---|---|---|
| Device | Example | HTL layer | 150 nm HTL | Blue Light- | | | Drive Volt. | Luminance | EL peak pos | |
| Example # | type | thickness (nm) | layer | emitting layer | ETL layer | Cathode | (V) | Yield (cd/A) | (nm) | ClEx |
| 7 | Comparison | 150 nm | 0 | 20 nm TBADN + | 35 nm Alq | 200 nm | 7.18 | 2.94 | 464 | 0.156 |
| | | | | 2% TBP | | MgAg | | | | |
| 8 | Inventive | 150 nm | 1% | 20 nm TBADN + | 35 nm Alq | 200 nm | 7.67 | 3.28 | 464 | 0.227 |
| | | | | 2% TBP | | MgAg | | | | |
| 9 | Inventive | 150 nm | 2% | 20 nm TBADN + | 35 nm Alq | 200 nm | 7.01 | 3.82 | 464 | 0.287 |
| | | | | 2% TBP | | MgAg | | | | |
| 10 | Inventive | 150 nm | 3% | 20 nm TBADN + | 35 nm Alq | 200 nm | 7.04 | 4.22 | 464 | 0.329 |
| | | | | 2% TBP | | MgAg | | | | |
| 11 | Inventive | 150 nm | 4% | 20 nm TBADN + | 35 nm Alq | 200 nm | 7.05 | 4.38 | 464 | 0.355 |
| | | | | 2% TBP | | MgAg | | | | |
| 12 | Inventive | 150 nm | 5% | 20 nm TBADN + | 35 nm Alq | 200 nm | 6.98 | 4.61 | 464 | 0.386 |
| | | | | 2% TBP | | MgAg | | | | |

### DEVICE EXAMPLES 13 TO 18

### Table 3

Devices of Examples 13 to 18 were prepared following structure of OLED 300 as shown in FIG. 3. NPB hole-transporting layer of 150 nm thickness was doped with varying amount of super rubrene DBzR compound with concentrations varying from 0% to 5%. It was found that the device of Example 13 has emission in the blue region of the electromagnetic spectrum, while the emission from devices of Example 14 to 18 is either white or bluish white or yellowish-white. Table 3 shows luminance, color coordinates, and drive voltage for devices 1 to 6 prepared using super rubrene DBzR as yellow dopant in the hole-transporting layer and TBP dopant in the TBADN blue light-emitting layer. The maximum luminance efficiency obtained from the devices of Examples 13 to 18 was about 5.9 cd/A. Table 1 shows that the devices using super rubrene DBzR have significantly higher luminance yield.

TABLE 3
White device characteristics using DBzR doping into HTL with TBADN + TBP as a Blue EML

| Device | | HTL layer | DBzR doping | | | | | | EL | | |
|---|---|---|---|---|---|---|---|---|---|---|---|
| Example | Example | thickness | into 150 nm | Blue Light- | | | Drive Volt. | Luminance | peak pos | | |
| # | type | (nm) | HTL layer | emitting layer | ETL layer | Cathode | (V) | Yield (cd/A) | (nm) | ClEx | ClEy |
| 13 | Comparitive | 150 nm | 0 | 20 nm TBADN + | 35 nm Alq | 200 nm | 7.8 | 3.1 | 468 | 0.16 | 0.25 |
| | | | | 2% TBP | | MgAg | | | | | |
| 14 | Inventive | 150 nm | 1% | 20 nm TBADN + | 35 nm Alq | 200 nm | 7.4 | 5.6 | 572 | 0.39 | 0.40 |
| | | | | 2% TBP | | MgAg | | | | | |
| 15 | Inventive | 150 nm | 2% | 20 nm TBADN + | 35 nm Alq | 200 nm | 7.5 | 5.9 | 576 | 0.43 | 0.41 |
| | | | | 2% TBP | | MgAg | | | | | |
| 16 | Inventive | 150 nm | 3% | 20 nm TBADN + | 35 nm Alq | 200 nm | 7.6 | 5.9 | 580 | 0.45 | 0.42 |
| | | | | 2% TBP | | MgAg | | | | | |
| 17 | Inventive | 150 nm | 4% | 20 nm TBADN + | 35 nm Alq | 200 nm | 7.5 | 5.9 | 464 | 0.46 | 0.42 |
| | | | | 2% TBP | | MgAg | | | | | |
| 18 | Inventive | 150 nm | 5% | 20 nm TBADN + | 35 nm Alq | 200 nm | 7.1 | 5.7 | 464 | 0.49 | 0.42 |
| | | | | 2% TBP | | MgAg | | | | | |

### DEVICE EXAMPLES 19 TO 24

### Table 4

Devices of Examples 19 to 24 were prepared following structure of OLED 300 as shown in FIG. 3. NPB hole-transporting layer of 150 nm thickness was doped with varying amounts of rubrene with concentrations varying from 0% to 5%. It was found that the device of Example 19 has emission in the blue region of the electromagnetic spectrum, while the emission from devices of Example 20 to 24 is either white or bluish white or yellowish-white. Table 4 shows luminance, color coordinates, and drive voltage for devices 19 to 24 prepared using rubrene as yellow dopant in the hole-transporting layer and B-1 as blue dopant in the TBADN blue light-emitting layer. The maximum luminance efficiency obtained from the devices of Examples 19 to 24 was about 6.6 cd/A.

TABLE 4
White device characteristics using Rubrene doping into HTL with TBADN + B-1 dopant as a Blue EML

| | | | Rubrene | | | | | Yield (cd/A) | | | |
|---|---|---|---|---|---|---|---|---|---|---|---|
| | | HTL layer | doping into | | | | Drive | @20 mA/cm2 | | | |
| Device | Example | thickness | 150 nm HTL | Blue Light-emitting | | | Volt. | (TK011216- | EL peak | | |
| Example # | type | (nm) | layer | layer | ETL layer | Cathode | (V) | 2_Rub) | pos (nm) | ClEx | ClEy |
| 19 | Comparison | 150 nm | 0 | 20 nm TBADN + 1.5% | 35 nm Alq | 200 nm | 7.8 | 6.3 | 472 | 0.18 | 0.33 |
| | | | | B-1 | | MgAg | | | | | |
| 20 | Comparison | 150 nm | 1% | 20 nm TBADN + 1.5% | 35 nm Alq | 200 nm | 6.4 | 2.2 | 472 | 0.24 | 0.39 |
| | | | | B-1 | | MgAg | | | | | |
| 21 | Comparison | 150 nm | 2% | 20 nm TBADN + 1.5% | 35 nm Alq | 200 nm | 7.7 | 6.6 | 560 | 0.37 | 0.44 |
| | | | | B-1 | | MgAg | | | | | |
| 22 | Comparison | 150 nm | 3% | 20 nm TBADN + 1.5% | 35 nm Alq | 200 nm | 7.8 | 6.6 | 560 | 0.36 | 0.44 |
| | | | | B-1 | | MgAg | | | | | |
| 23 | Comparison | 150 nm | 4% | 20 nm TBADN + 1.5% | 35 nm Alq | 200 nm | 7.7 | 6.2 | 560 | 0.38 | 0.44 |
| | | | | B-1 | | MgAg | | | | | |
| 24 | Comparison | 150 nm | 5% | 20 nm TBADN + 1.5% | 35 nm Alq | 200 nm | 7.5 | 6.2 | 560 | 0.38 | 0.44 |
| | | | | B-1 | | MgAg | | | | | |

### DEVICE EXAMPLES 25 TO 30

### Table 5

Devices of Examples 25 to 30 were prepared following structure of OLED 300 as shown in FIG. 3. NPB hole-transporting layer of 150 nm thickness was doped with varying amounts of super rubrene DBzR compound with concentrations varying from 0% to 5%. It was found that the device of Example 25 has emission in the blue region of the electromagnetic spectrum, while the emission from devices of Example 26 to 30 is either white or bluish white or yellowish-white. Table 5 shows luminance, color coordinates, and drive voltage for devices 25 to 30 prepared using rubrene as yellow dopant in the hole-transporting layer and B-1 as blue dopant in the TBADN blue light-emitting layer. The maximum luminance efficiency obtained from the devices of Examples 25 to 30 was about 8.5 cd/A. One can see that, relative to the devices in Table 4, the devices using super rubrene DBzR have significantly higher luminance yield.

This is an important feature of this invention that doping super rubrene DBzR in the NPB hole-transporting layer adjacent to a blue light light-emitting layer consisting of TBADN host with B-1 dopant produce white light OLED with very efficiency. The efficiency from the device of Example 28 has the highest efficiency among the various combinations of yellow and blue dopants.

TABLE 5
White device characteristics using DBzR doping into HTL with TBADN + B-1 dopant as a Blue EML

| | | | DBzR | | | | | | | | |
|---|---|---|---|---|---|---|---|---|---|---|---|
| | | HTL layer | doping into | | | | Drive | | | | |
| Device | Example | thickness | 150 nm | Blue Light- | ETL | | Volt.(V) | Luminance | EL peak | | |
| Example # | type | (nm) | HTL layer | emitting layer | layer | Cathode | @J = 20 | Yield (cd/A) | pos (nm) | ClEx | ClEy |
| 25 | Comparison | 150 nm | 0 | 20 nm TBADN + | 35 nm | 200 nm MgAg | 7.0 | 6.8 | 472 | 0.18 | 0.35 |
| | | | | 1.5% B-1 | Alq | | | | | | |
| 26 | Inventive | 150 nm | 1% | 20 nm TBADN + | 35 nm | 200 nm MgAg | 7.0 | 8.0 | 472 | 0.26 | 0.40 |
| | | | | 1.5% B-1 | Alq | | | | | | |
| 27 | Inventive | 150 nm | 2% | 20 nm TBADN + | 35 nm | 200 nm MgAg | 7.2 | 8.5 | 560 | 0.32 | 0.42 |
| | | | | 1.5% B-1 | Alq | | | | | | |
| 28 | Inventive | 150 nm | 3% | 20 nm TBADN + | 35 nm | 200 nm MgAg | 7.2 | 8.3 | 472 | 0.34 | 0.41 |
| | | | | 1.5% B-1 | Alq | | | | | | |
| 29 | Inventive | 150 nm | 4% | 20 nm TBADN + | 35 nm | 200 nm MgAg | 7.1 | 8.0 | 572 | 0.36 | 0.42 |
| | | | | 1.5% B-1 | Alq | | | | | | |
| 30 | Inventive | 150 nm | 5% | 20 nm TBADN + | 35 nm | 200 nm MgAg | 7.2 | 8.0 | 572 | 0.37 | 0.42 |
| | | | | 1.5% B-1 | Alq | | | | | | |

### DEVICE EXAMPLES 31 TO 33

### Table 6

Another important feature of this invention is that white light can be produced by an OLED by doping super rubrene both in the NPB hole-transporting layer 640 and in the Alq electron-transporting layer 661 as shown in FIG. 6. The blue light-emitting layer the OLED device of FIG. 6 consists of TBADN host and the B-1 dopant. These devices have high luminance yield and higher operational stability as compared to those obtained by super rubrene doping in either the hole-transporting layer or the electron-transporting layer.

TABLE 6
White device characteristics using DBzR doping into HTL and Alq ETL layer with TBADN host & B-1 as dopant in the Blue LEL

| | | | DBzR | | | | | | | | | | |
|---|---|---|---|---|---|---|---|---|---|---|---|---|---|
| | | | doping | | Blue dopant | | | Total | Drive | Yield | EL | | |
| Device | | HTL | into 150 nm | TBADN | B-1 in the | DBzR into | AlQ | DBzR into | Volt. | (cd/A) | peak | | |
| Exam- | Example | layer | NPB HTL | thickness | TBADN | 20 nm Alq | undoped | HTL + | (V)@ | @20 | pos | | |
| ple # | type | (NPB) | layer | (nm) | layer (%) | ETL layer | ETL layer | ETL | J = 20 | mA/cm2 | (nm) | ClEx | ClEy |
| 31 | Inventive | 150 nm | 3.50% | 20 nm | 2% | 0.00% | 15 nm | 3.50% | 7.5 | 9.25 | 472 | 0.33 | 0.43 |
| 32 | Inventive | 150 nm | 0.00% | 20 nm | 2% | 2.50% | 15 nm | 2.50% | 8.4 | 5.46 | 472 | 0.28 | 0.41 |
| 33 | Inventive | 150 nm | 2.00% | 20 nm | 2% | 1.50% | 15 nm | 3.50% | 8.3 | 6.61 | 472 | 0.32 | 0.43 |

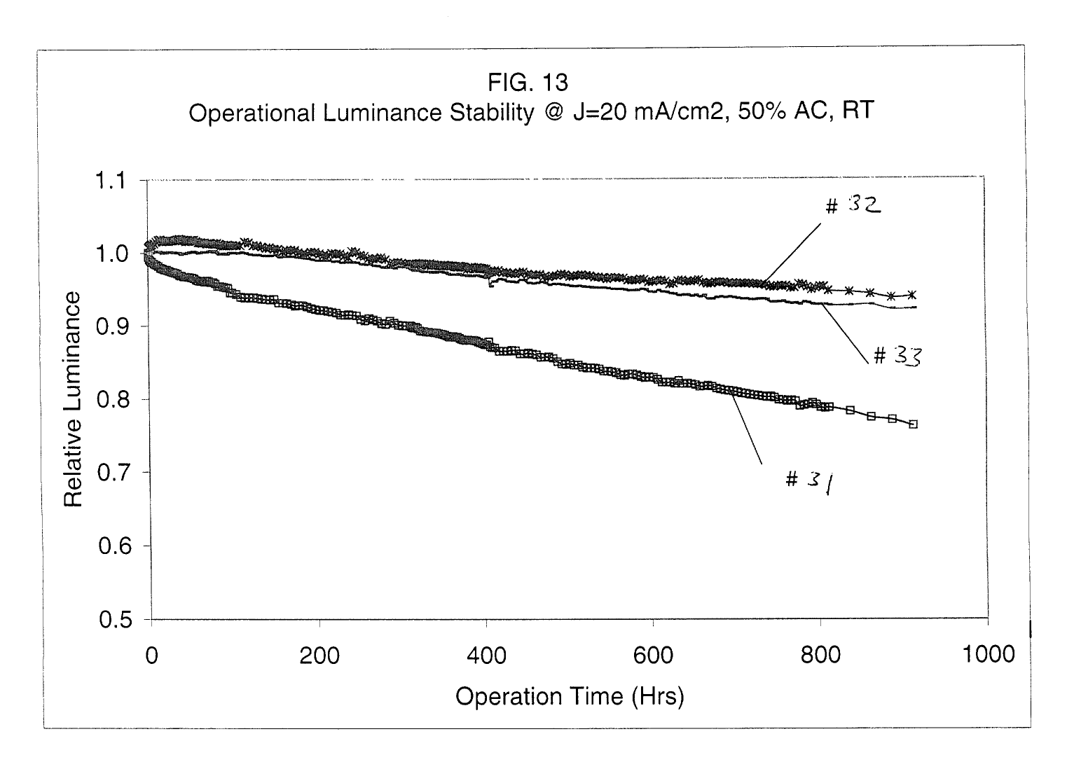

The operational stability of the encapsulated OLED devices in ambient environments was found by measuring the changes in the drive voltage and the luminance as a function of time when OLED devices were operated at a constant current density of 20 mA/cm². White OLED devices prepared by following the different structures of this invention have high operational stability. FIG. 13 shows the operational luminance stability for the devices of Examples 31 to 33.

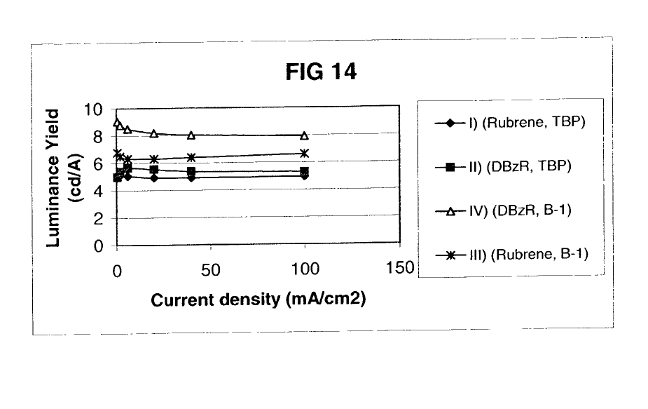

FIG. 14 shows relative luminance as a function of current density for devices with several different combinations of the blue dopant and the yellow dopants:

I) Rubrene with TBP;

II) DBzR with TBP;

III) Rubrene with B-1; and

IV) DBzR with B-1.

It is clear that the DBzR yield superior device performance relative to rubrene. Also, the combination of DBzR super rubrene yellow emitting dopant into NPB HTL layer and B-1 blue emitting dopant into TBADN host give the best efficiency. It also gives the highest stability and white emitting light.

The invention has been described in detail with particular reference to certain preferred embodiments thereof, but it will be understood that variations and modifications can be effected within the spirit and scope of the invention. For example, multiple dopants can be used in any of the hole-transporting, electron-transporting or light-emitting layers.

### Parts List

100 OLED with a simple structure

110 substrate

120 anode

140 light-emitting layer

170 cathode

200 OLED with a multilayer structure

210 substrate

220 light-transmissive anode

230 hole-injecting layer (HIL)

240 hole-transporting layer (HTL)

250 light-emitting layer (LEL)

260 electron-transporting layer (ETL)

270 cathode

300 OLED

310 substrate

320 anode

330 hole-injecting layer

340 hole-transporting layer

350 light-emitting layer

360 electron-transporting layer

370 cathode

400 OLED

410 substrate

420 anode

430 hole-injecting layer

441 hole-transporting sub layer

442 hole-transporting sub layer

450 light-emitting layer

460 electron-transporting layer

470 cathode

500 OLED

510 substrate

520 anode

530 hole-injecting layer

540 hole-transporting layer

550 blue light-emitting layer

561 electron-transport sub layer

562 electron-transport sub layer

570 cathode

600 OLED

610 substrate

620 anode

630 hole-injecting layer

640 hole-transporting layer

650 blue light-emitting layer

661 electron-transporting sub layer

662 electron-transporting sub layer

670 cathode

700 OLED

710 substrate

720 anode

730 hole-injecting layer

741 hole-transporting layer sub layer

742 hole-transporting layer sub layer

750 blue light-emitting layer

761 electron-transport sub layer

762 electron-transport sub layer

770 cathode

800 OLED

810 substrate

820 anode

830 hole-injecting layer

840 hole-transporting layer

850 light-emitting layer

861 electron-transport sub layer

862 electron-transport sub layer

870 cathode

900 OLED

910 substrate

920 anode

930 hole-injecting layer

941 hole-transport sub layer

942 hole-transport sub layer

950 blue light-emitting layer

961 electron-transport sub layer

962 electron-transport sub layer

970 cathode

1000 OLED

1010 substrate

1020 anode

1030 hole-injecting layer

1040 hole-transporting layer

1050 blue light-emitting layer

1061 electron-transporting sub layer

1062 electron-transporting sub layer

1063 electron-transporting sub layer

1070 cathode

1100 OLED

1110 substrate

1120 anode

1130 hole-injecting layer

1140 hole-transporting layer

1150 blue light-emitting layer

1161 electron-transport sub layer

1162 electron-transport sub layer

1163 electron-transport sub layer

1170 cathode

1200 OLED

1210 substrate

1220 anode

1230 hole-injecting layer

1241 hole-transporting layer sub layer

1242 hole-transporting layer sub layer

1250 light-emitting layer

1261 electron-transport sub layer 1

1262 electron-transport sub layer 2

1263 electron-transport sub layer 3

What is claimed is:

1. An organic light-emitting diode (OLED) device which produces substantially white light, comprising:
a) an anode;
b) a hole-transporting layer disposed over the anode;
c) a blue light-emitting layer doped with a blue light-emitting compound disposed directly on the hole-transporting layer;
d) an electron-transporting layer disposed over the blue light-emitting layer;
e) a cathode disposed over the electron-transporting layer; and
f) the hole-transporting layer or electron-transporting layer, or both the hole-transporting layer and electron-transporting layer, being selectively doped with the following compound or derivatives thereof which emits light in the yellow region of the spectrum which corresponds to an entire layer or a partial portion of a layer in contact with the blue light-emitting layer: 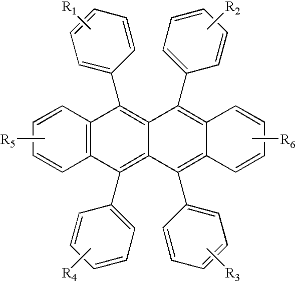
wherein R₁, R₂, R₃, R₄, R₅, R₆ represent one or more substituents on each ring where each substituent is individually selected from the following groups:
Group 1: hydrogen, or alkyl of from 1 to 24 carbon atoms;
Group 2: aryl or substituted aryl of from 5 to 20 carbon atoms;
Group 3: carbon atoms from 4 to 24 necessary to complete a fused aromatic ring of naphthyl, anthracenyl, phenanthryl, pyrenyl, or perylenyl;
Group 4: heteroaryl or substituted heteroaryl of from 5 to 24 carbon atoms such as thiazolyl, furyl, thienyl, pyridyl, quinolinyl or other heterocyclic systems, which may be bonded via a single bond, or may complete a fused heteroaromatic ring system;
Group 5: alkoxylamino, alkylamino, or arylamino of from 1 to 24 carbon atoms; or
Group 6: fluorine, chlorine, bromine or cyano,
except R₅ and R₆ do not form a fused ring, and at least one of the substituents R₁, R₂, R₃, and R₄ are substituted with a group other than hydrogen.

2. The OLED device of claim 1 wherein the yellow emitting dopants includes 6,11-diphenyl-5,12-bis(4-(6-methyl-benzothiazol-2-yl)phenyl)naphthacene (DBzR) or 5,6,11,12-tetra(2-naphthyl)naphthacene (NR), the formulas of which are shown below:

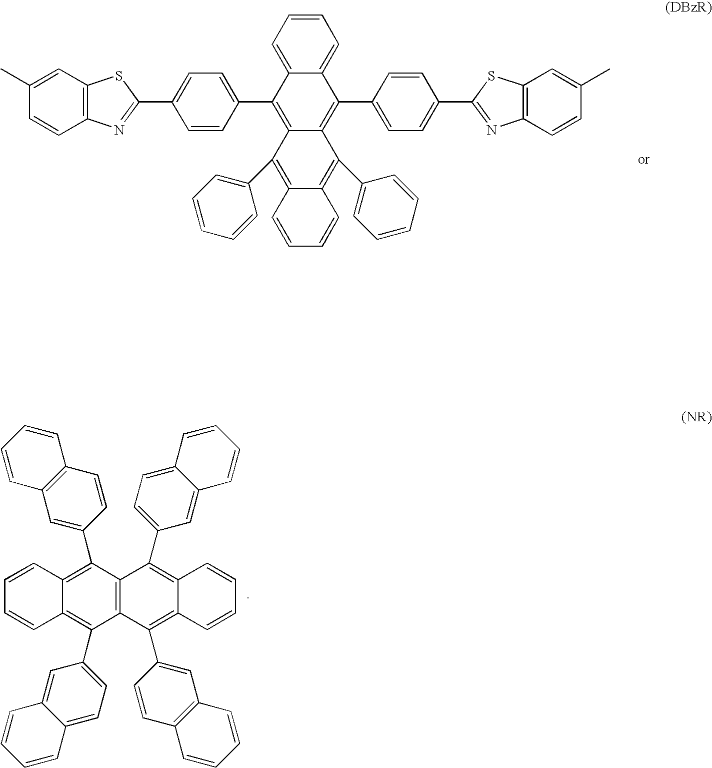

3. The OLED device of claim 2 wherein the concentration of yellow emitting dopants 6,11-diphenyl-5,12-bis(4-(6-methyl-benzothiazol-2-yl)phenyl)naphthacene (DBzR) or 5,6,11,12-tetra(2-naphthyl)naphthacene (NR) is in a range of greater than 0 and less than 30% percent by volume of the host material.

4. The OLED device of claim 2 wherein the concentration of yellow emitting dopants 6,11-diphenyl-5,12-bis(4-(6-methyl-benzothiazol-2-yl)phenyl)naphthacene (DBZR) or 5,6,11,12-tetra(2-naphthyl)naphthacene (NR) is preferably in a range of greater than 0 and less than 15% percent by volume of the host material.

5. The OLED device of claim 1 wherein the blue dopant includes distyrylamine derivatives as shown by the formula

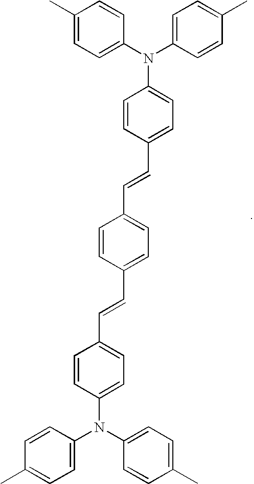

6. The OLED device of claim 1 wherein the blue emitting dopant further includes perylene and its derivatives.

7. The OLED device of claim 6 wherein the perylene derivative is 2,5,8,11-tetra-tert-butyl perylene (TBP).

8. The OLED device of claim 1 wherein the blue dopant is represented by the following formulas:

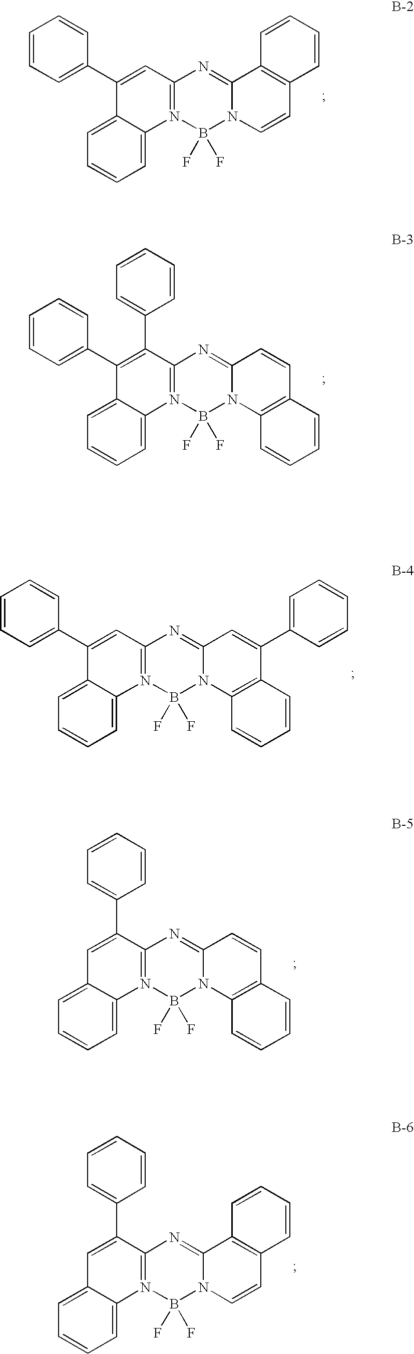

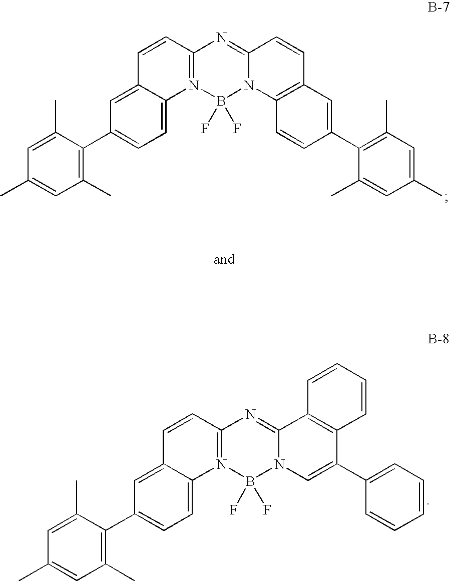

9. The OLED device of claim 1 wherein the concentration of blue emitting dopants, is in the range of greater than 0 and less than 10% percent by volume of the host material.

10. The OLED device of claim 1 wherein thickness of the hole-transporting layer is between 10 nm-300 nm.

11. The OLED device of claim 1 wherein the hole-transporting layer includes two or more sub layers, the sub layer closest to the blue light-emitting layer being doped with yellow emitting dopants.

12. The OLED device of claim 11 wherein the dopant in the hole transport material is 6,11-diphenyl-5,12-bis(4-(6-methyl-benzothiazol-2-yl)phenyl)naphthacene (DBzR); or 5,6,11,12-tetra(2-naphthyl)naphthacene (NR), and the thickness of the layer containing yellow dopant is in a range between 1 nm-300 nm.

13. The OLED device of claim 1 wherein thickness of the blue light-emitting layer is in a range between 10 nm-100 nm.

14. The OLED device of claim 1 wherein a hole-injecting layer is provided between the anode and the hole-transporting layer.

15. The OLED device of claim 14 wherein the hole-injecting layer comprises CFx, CuPC, or m-MTDATA.

16. The OLED device of claim 14 wherein the thickness of hole-injecting layer is 0.1 nm-100 nm.

17. The OLED device of claim 1 wherein thickness of the electron-transporting layer is in a range between 10 nm-150 nm.

18. The OLED device of claim 1 wherein the cathode is selected from the group consisting of LiF/Al, Mg:Ag alloy, Al—Li alloy, and Mg—Al alloy.

19. The OLED device of claim 1 wherein the cathode is transparent.

20. The OLED device of claim 2 wherein the electron-transporting layer is transparent.

21. The organic light-emitting diode (OLED) device of claim 1 wherein the electron-transporting layer is doped with a green light-emitting dopant or a combination of green and yellow light-emitting dopants.

22. The OLED device of claim 21 wherein of the green dopant in the electron-transporting layer includes a coumarin compound.

23. The OLED device of claim 22 wherein the coumarin compound includes C545T or C545TB.

24. The OLED device of claim 21 wherein the green light-emitting dopant has the formula: 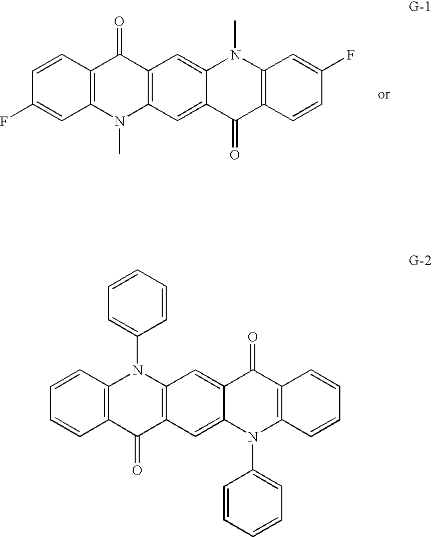
and compounds suitably represented by Formulas

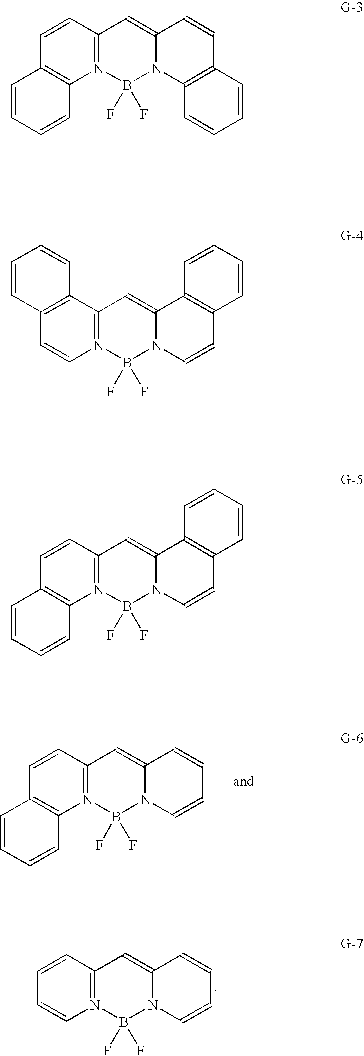

25. The OLED device of claim 21 wherein green dopant concentration is between 0.1-5% percent by volume of the host material.

26. The OLED device of claim 1 further including buffer layer disposed on the cathode layer.

27. The OLED device of claim 26 wherein thickness of the buffer layer is in a range between 1 nm-1000 nm.

28. The OLED device of claim 1 further including a color filter array disposed on the substrate or over the cathode.

29. The OLED device of claim 25 further including a color filter array disposed on the buffer layer.

30. The OLED device of claim 1 further including thin film transistors (TFTs) on the substrate to address the individual pixels.

31. The OLED device of claim 1 wherein the hole-transporting layer includes an aromatic tertiary amine.

32. The OLED device of claim 1 wherein the electron-transporting layer includes copper phthalocyanine compound.

33. The OLED device of claim 1 wherein the blue light-emitting layer includes host material selected from the group consisting of: [chemical structure]
